(19) United States
(12) Patent Application Publication
(10) Pub. No.: US 2011/0043083 A1
(43) Pub. Date: Feb. 24, 2011

(54) VEHICLE ELECTRIC ROTATING MACHINE AND METHOD FOR MANUFACTURING SAME

(75) Inventors: Hiroshi Hamada, Anjo-shi (JP); Tooru Ooiwa, Toyota-shi (JP); Keiichi Yoshimura, Anjo-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-city (JP)

(21) Appl. No.: 12/857,887

(22) Filed: Aug. 17, 2010

(30) Foreign Application Priority Data
Aug. 20, 2009 (JP) 2009-190656

(51) Int. Cl. H02K 7/10; B23P 11/00

(52) U.S. Cl. 310/75 R; 29/428

(57) ABSTRACT

The vehicle electric rotating machine includes a pulley unit having an opening portion formed in an axial front end thereof, and configured to perform at least one of transmission and reception of a rotation drive force to and from the rotation shaft of the rotor, and a lid attached to the opening portion to close an internal space of the pulley unit. The rotor includes a rotor side receiving surface in contact with one axial end surface of an inner ring of the bearing rotatably supporting the rotor. The pulley unit includes a pulley side receiving surface in contact with the other axial end surface of the inner ring. An air passage enabling air communication between the internal space of the pulley unit closed by the lid and ambient space is formed in at least one of the rotor side receiving surface, the pulley side receiving surface, and the lid.

This application claims priority to Japanese Patent Application No. 2009-190656 filed on Aug. 20, 2009, the entire contents of which are hereby incorporated by reference.

### BACKGROUND OF THE INVENTION

1. Field of the Invention

The present invention relates to a vehicle electric rotating machine mounted on a vehicle such as a passenger car or a truck.

2. Description of Related Art

In recent years, there is a trend that all the pulleys of accessories mounted on a vehicle are wound with a single poly-V belt to be serpentine-driven in view of improving assembly workability. In a system in which accessories mounted on a vehicle are driven through a poly-V belt, if the behavior of an accessory having a large inertia becomes unstable, the rotation of a vehicle engine becomes unstable. Generally, of all accessories mounted on a vehicle, a vehicle AC generator has the largest inertia, and also has a large pulley ratio. Accordingly, there are various techniques to reduce the effect to the rotation variation of a vehicle engine by the vehicle AC generator. One of such techniques is to use a one-way clutch-pulley unit having a structure in which a one-way clutch is disposed between the rotation shaft of a vehicle AC generator and a pulley section disposed concentrically around the rotation shaft. For example, refer to Japanese Patent Applications Laid-Open No. 8-226462 (Patent Document 1) and No. 2002-357263 (Patent Document 2). Another one of such techniques is to use a unitized decoupler pulley having a structure in which a coil-like spring with a shock-absorbing damper function is disposed between the rotation shaft of a vehicle AC generator and a pulley section disposed concentrically around the rotation shaft. For example, refer to Published Japanese Translation No. 2001-523325 of PCT Application (Patent Document 3). In accordance with the above techniques, it is possible to reduce the rotation variation of a vehicle AC generator to thereby stabilize the rotation of a vehicle engine.

Meanwhile, since a vehicle AC generator is mounted on a vehicle engine, the thermal stress of a vehicle AC generator is increasing year by year because of the temperature increase due to the increase of its output power, in addition to the heat emitted from the vehicle engine. Further, the above one-way clutch-pulley unit or the unitized decoupler pulley of a vehicle AC generator mounted on a vehicle is subjected to harsh environment when the vehicle is used in a high salt area, a high-temperature and high-humidity area, or an area having a long rainy season. Accordingly, for the purpose of permanently providing the function of suppressing the rotation variation of a vehicle AC generator, and absorbing shock, they are configured such that muddy water or salt water can be prevented from entering the pulley by attaching a lid to the opening portion of the pulley on the side opposite to the rotor of the vehicle AC generator after they are assembled to the vehicle AC generator.

Incidentally, the inside of each of the one-way clutch-pulley unit and the unitized decoupler pulley is air-tight sealed. Accordingly, they have a problem in that the lid is difficult to attach because the air cannot escape from the inside of the pulley although the pressure inside the pulley increases considerably at the time of attaching the lid to the pulley, causing the lid to be deformed. Further, even if the lid has been attached successfully, there may occur a case in which the air inside the pulley expands while the vehicle runs due to heat emitted from the vehicle engine, and as a result, the lid comes loose or falls. In this case, water or salt water may enter the inside of the pulley.

### SUMMARY OF THE INVENTION

The present invention provides a vehicle electric rotating machine: comprising:

a rotor including a rotation shaft rotatably supported by a first bearing;

a pulley unit having an opening portion formed in an axial front end thereof, and configured to perform at least one of transmission and reception of a rotation drive force to and from the rotation shaft; and

a lid attached to the opening portion to close an internal space of the pulley unit;

the rotor including a rotor side receiving surface in contact with a first axial end surface of an inner ring of the first bearing,

the pulley unit including a pulley side receiving surface in contact with a second axial end surface of the inner ring of the first bearing,

wherein an air passage enabling air communication between the internal space of the pulley unit closed by the lid and ambient space of the pulley unit is formed in at least one of the rotor side receiving surface, the pulley side receiving surface, and the lid.

The present invention also provides a method of manufacturing a vehicle AC generator including a rotor having a rotation shaft rotatably supported by a first bearing, a pulley unit having an opening portion formed in an axial front end thereof, and configured to perform at least one of transmission and reception of a rotation drive force to and from the rotation shaft, and a lid attached to the opening portion to close an internal space of the pulley unit,

the method comprising the steps of:

assembling the pulley unit to an axial front end of the rotation shaft; and

attaching the lid to the opening portion of the pulley unit while forming an air passage in the lid to enable air communication between the internal space of the pulley unit closed by the lid and ambient space of the pulley unit.

According to the present invention, it is possible for the air inside the pulley unit of a vehicle AC generator to escape to ambient space at the time of attaching a lid to the opening portion of the pulley unit to improve workability of attaching the lid, and to reliably prevent foreign matter from entering the inside of the pulley unit after the lid is attached.

Other advantages and features of the invention will become apparent from the following description including the drawings and claims.

### BRIEF DESCRIPTION OF THE DRAWINGS

In the accompanying drawings:

FIG. 1 is a cross-sectional view of a vehicle AC generator according to an embodiment of the invention;

FIG. 2 is an enlarged cross sectional view of FIG. 1 showing air passages formed respectively in a rotor receiving surface and a pulley receiving surface;

FIG. 3 is front view of a lid to be attached to an opening portion of a pulley unit of the vehicle AC generator of the embodiment;

FIG. 4 is a diagram explaining a process to attach the lid by use of a lid attaching jig;

FIG. 5 is a diagram showing a modification of the lid;

FIG. 6 is a diagram showing another modification of the lid;

FIG. 7 is a diagram showing another modification of the lid;

FIG. 8 is a diagram showing another modification of the lid;

FIG. 9 is a diagram showing another modification of the lid; and

FIG. 10 is a diagram showing another modification of the lid.

### PREFERRED EMBODIMENTS OF THE INVENTION

### First Embodiment

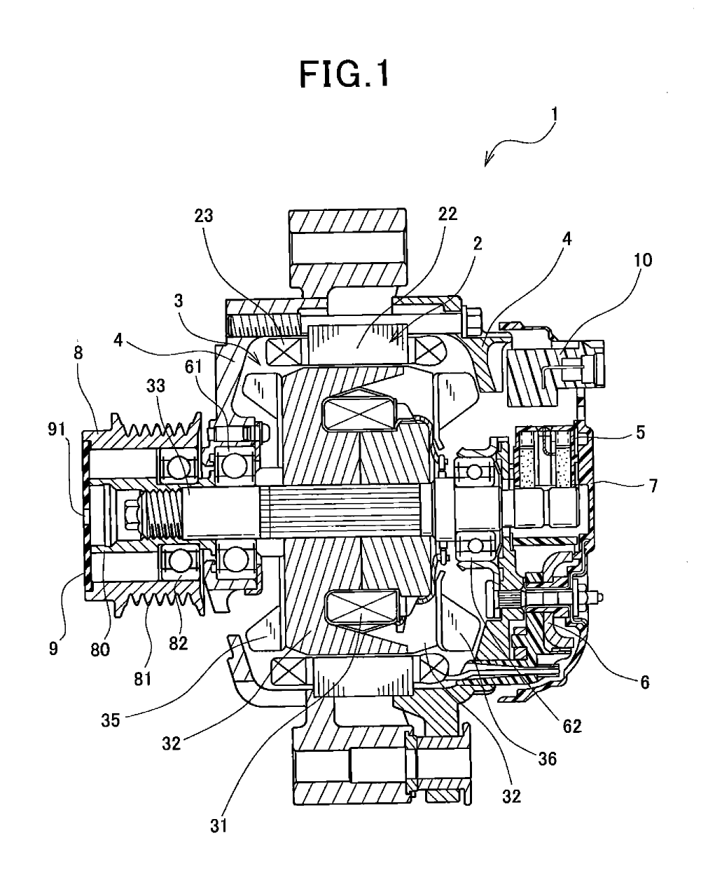

FIG. 1 is a cross-sectional view of a vehicle AC generator 1 according to an embodiment of the invention. The vehicle AC generator 1 (may be referred to simply as generator 1 hereinafter) includes a stator 2, a rotor 3, a frame 4, a brush device 5, a rectifier device 6, a rear cover 7, a pulley unit 8 and a lid 9.

The stator 2, which is disposed around the circumference of the rotor 3, includes a stator core 22, and a stator winding 23 wound on the slots formed in the stator core 22. The rotor 3 is has a structure in which insulated copper wires wound concentrically in a cylindrical shape as a field winding 31 is disposed so as to be held by pole cores 32 each having a plurality of pole claw sections at its inner and outer sides with respect to a rotation shaft 33 of the rotor 3. Cooling fans 35 and 36 are fixed respectively to the end surfaces of the pole cores by welding. The rotor 3 rotates together with the rotation shaft 33.

The frame 4 houses and holds the stator 2 and the rotor 3 such that the rotor 3 is supported rotatably around the rotation shaft 33 through bearings 61 and 62, and the stator 2 is fixedly disposed around the circumference of the pole cores 32 with a gap therebetween.

The brush device 5, which is for passing an excitation current from the rectifier device 6 to the field winding 31 of the rotor 3, includes brushes pressed against slip rings provided in the rotation shaft 33 of the rotor 3. The rectifier device 6 is for rectifying a three-phase AC voltage outputted from the stator winding 23 to generate a DC voltage. The rear cover 7 covers the brush device 5, the rectifier device 6 and an IC regulator 10 mounted outside the frame 4 on the rear side to protect them.

The rotor 3 of the generator 1 having the above structure rotates in a predetermined direction when one-way rotation drive force is transmitted to the pulley unit 8 from a vehicle engine (not shown). In this state, by applying an excitation voltage from the outside to the field winding 31 of the rotor 3, the claw sections of the pole cores 32 are energized, the three-phase AC voltage is generated by the stator winding 32, and the DC voltage is outputted from the rectifier device 6.

Next, the pulley unit 8 and the structure around the pulley unit 8 are explained in detail. The pulley unit 8 includes a pulley shaft 80 mounted on the rotation shaft 33, a pulley 81 formed with pulley grooves at its outer periphery and disposed concentrically outwardly of the pulley shaft 80, and a bearing 82 filled with grease and disposed between the pulley shaft 80 and the pulley 81. The pulley unit 8 includes a one-way clutch mechanism to transmit the rotation drive force in a predetermined direction transmitted to the pulley 81 to the pulley shaft 80. To implement this one-way clutch mechanism, in addition to the bearing 82, another bearing is provided between the pulley shaft 80 and the pulley 81 at a distance to the bearing 82 in the axial direction, and a plurality of rollers are provided between these two bearing although not shown in FIG. 1. In stead of the rollers, balls may be provided. Each of the rollers is disposed in a space whose lateral cross section has a wedge-like shape formed between the pulley shaft 80 and the pulley 81. When the pulley 81 rotates in the predetermined direction, the roller is held in the radially narrow portion of the wedge-like space, so that the drive force is transmitted from the pulley 81 to the pulley shaft 80. On the other hand, when the pulley 81 rotates in the direction opposite to the predetermined direction, the roller is located in the radially wide portion, so that the drive force is not transmitted from the pulley 81 to the pulley shaft 80.

The pulley 81 has a cylindrical shape at its inner periphery, and has a step shape portion at its front end. In this embodiment, the lid 9 is attached to this step shape portion to close an opening portion formed in the axial end surface of the pulley unit 8 on the front end side of the pulley unit 8. The lid 9 is made of elastic material such as rubber. The outer diameter of the lid 9 is slightly larger than the inner diameter of the step shape portion, so that the lid 9 can be attached to the pulley unit 8 by being pressure-inserted into the step shape portion. The lid 9 is formed with a slit 91 at its center portion.

When the lid 9 is attached to close the internal space of the pulley unit 8, there is provided an air passage enabling air communication between this internal space and ambient space. In more detail, there is provided an air passage in at least one of (1) the rotor side receiving surface (the receiving surface on the side of the rotor 3) in abutment with one axial end surface of the inner ring of the bearing 61, (2) the pulley side receiving surface (the receiving surface on the side of the pulley shaft 80) in abutment with the other axial end surface of the inner ring of the bearing 61, and (3) at least one portion of the lid.

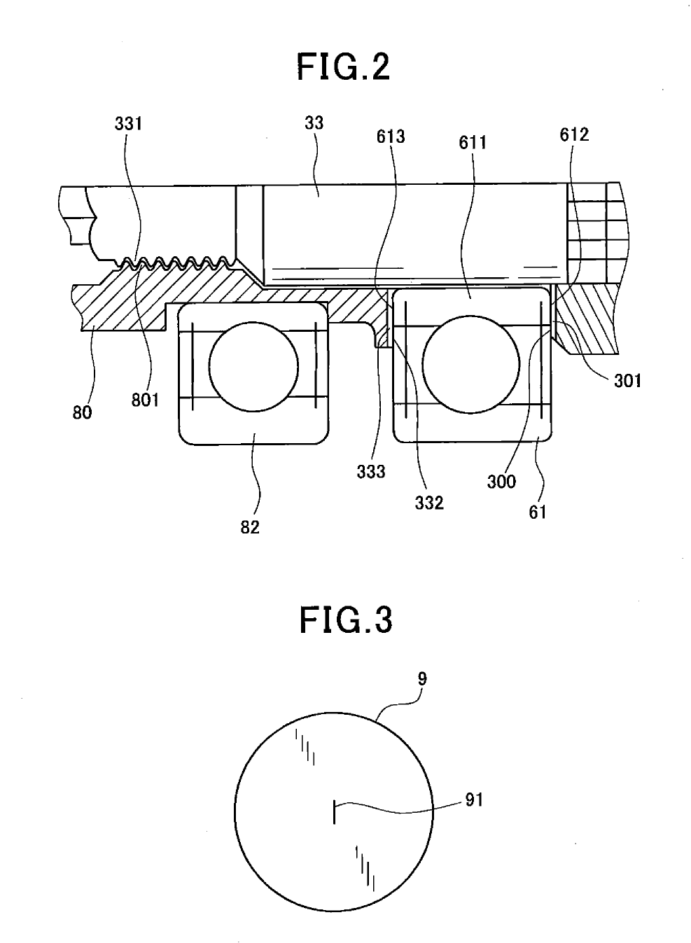

FIG. 2 is an enlarged cross-sectional view of FIG. 1 showing the air passages provided respectively in the rotor side receiving surface and the pulley side receiving surface. As shown in FIG. 2, the rotation shaft 33 is formed with a male thread portion 331 at its front end, and the pulley shaft 80 is formed with a female thread portion 801 at is inner periphery. The pulley unit 8 is secured to the rotation shaft 33 by screwing the pulley shaft 80 to the rotation shaft 33. Also, by screw-securing the pulley shaft 80, the one axial end surface 612 of the inner ring 611 of the bearing 61 is brought into intimate contact with the rotor side receiving surface 300, and the other axial end surface 613 of the inner ring 611 of the bearing 61 is brought into intimate contact with the pulley side receiving surface 332. In this embodiment, a groove 301 is formed on the intimate contact surface between the axial end surface 612 and the rotor side receiving surface 300 so as to extend in the circumferential direction. Also, a groove 333 is formed on the intimate contact surface between the axial end surface 613 and the rotor side receiving surface 300 so as to extend in the circumferential direction. Each of the grooves 301 and 333 may be single or plural in number. In the example shown in FIG. 2, the groove 301 is formed on the rotor side receiving surface 300, and the groove 333 is formed on the pulley side receiving surface 332. However, the grooves 301 and 333 may be formed respectively on the axial end surfaces 612 and 613, or on each of the surfaces forming the intimate contact surface.

In this embodiment, the inner diameter of the inner ring 611 is slightly larger than the outer diameter of the rotation shaft 33 in order to assemble the rotor 3 by inserting the rotation shaft 33 into the inner ring 611 of the bearing 61. Accordingly, there exists a clearance through which the air can pass through between the rotation shaft 33 and the inner ring 611. By the same reason, a clearance exists between the rotation shaft 33 and the pulley shaft 80. Further, when the female thread portion 801 of the pulley shaft 80 is screwed into the male thread portion 331 at the front of the rotation shaft 33, since not all their parts are in intimate contact, there exists a. clearance also between them. Hence, by forming the grooves 301 and 333 extending in the circumferential direction, it is possible that the air inside the pulley unit 8 can escape to the ambient space through the clearances around the rotation shaft 33.

This makes it possible to prevent the pressure in the internal space of the pulley unit 8 from increasing excessively at the time of attaching the lid to the pulley unit 8, because the air in the internal space can escape through the grooves 301 and 333. As a result, workability of attaching the lid 9 is improved. Further, it is possible to prevent the lid 9 from becoming loose or falling due to pressure increase in the internal space to thereby reliably prevent foreign matter or water from entering the internal space so that the bearing 61 in direct contact with the pulley unit 8 can be prevented from being flooded.

Further, since the air inside the internal space of the pulley unit 8 can escape through the grooves 301 and 333, it is possible to prevent the grease filled in the bearing 82 of the pulley unit 8 from leaking with the increase of the pressure in the internal space. Further, since it is possible to reliably prevent foreign matter from entering the inside of the clutch mechanism, the components including the bearing 82 constituting the clutch mechanism can be prevented from corroding or being clogged.

FIG. 3 is front view of the lid 9. As shown in FIG. 3, the lid 9 is formed with a slot 91 at its center. Since the lid 9 is made of elastic material as described in the foregoing, the slit 91 is closed when not being applied with external force. The slit 91 is deformed to make a through hole at the time of being attached to the pulley unit 8, the through hole serving as an air passage.

Next, a method of manufacturing the generator 1 attached with the lid 9 having the slit 91 is explained. This method includes step A and step B described below.

Step A is a step for mounting the pulley unit 8 to the front end of the rotation shaft 33. The step A is performed by rotating the pulley shaft 80 by inserting a hexagon wrench into the front end portion (whose inner surface may have a hexagonal cross-sectional shape), and screwing the female thread portion 801 of the pulley shaft 80 to the male thread portion 331 of the rotation shaft 33.

Step B is a step for attaching the lid 9 to the opening portion of the pulley unit 8, while forming the air passage in the lid 9, the air passage enabling air communication between the internal space of the pulley unit 8 closed by the lid 9 and ambient space. At step B, the air passage is formed by causing the slit 91 to open by applying external force to the lid 9. After attaching the lid 9 to the pulley unit 8, the external force is removed, as a result of which the slit 91 is closed.

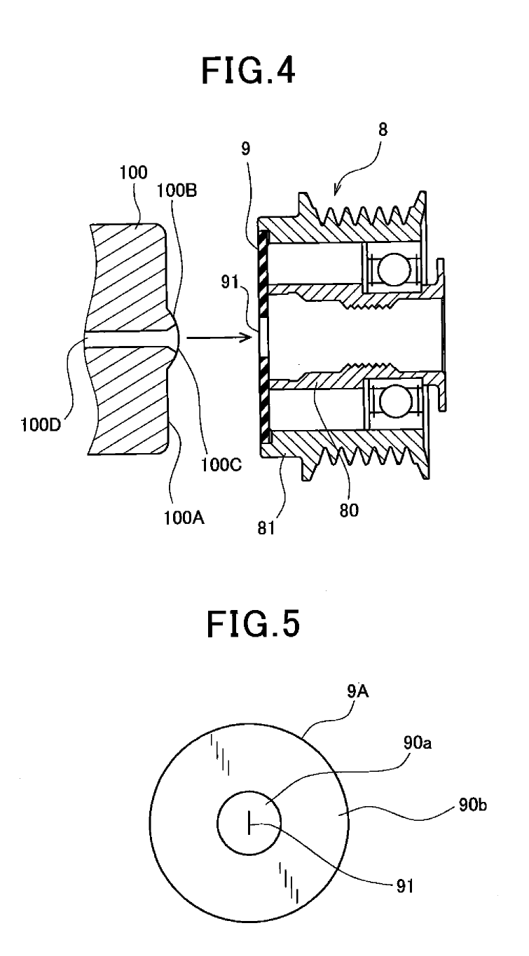

FIG. 4 is a diagram explaining a process to attach the lid 9 by use of a lid attaching jig 100 appropriate to perform step B. The lid attaching jig 100 has a pressing surface 100A having the same diameter as the lid 9. The pressing surface 100A is formed with a convex portion 100B at its center. The convex portion 100B is formed with a slit 100C having a shape corresponding to that of the slit 91 of the lid 9 (may be the same shape as the slit 9), which is connected with an air passage D.

At the time of attaching the lid 9 to the pulley unit 8 by performing step B, the whole of the surface of the lid 9 is pressed by the lid attaching jig 100 with the convex portion 100B of the lid attaching jig 100 being aligned with the slit 91 of the lid 9. At this time, the slit 91 is deformed due to being pressed by the convex portion 100B, and as a result, the slit 91 opens. The air escaped from the internal space of the pulley unit 8 through this opening is discharged through the slit 100C formed in the convex portion 100B of the lid attaching jig 100 and the air passage 100D.

As explained above, it is possible to form an air passage by causing the slit 91 to open by applying an external force thereto, and to prevent entry of foreign matter by causing the slit 91 to close by removing the external force after completion of the attaching work of the lid 9.

FIG. 5 is a diagram showing a modification of the lid 9. In the example shown in FIG. 3, the whole of the lid 9 is made of elastic material. However, it is possible that only a part of the lid 9 including the slit 91 is made of elastic material, and the other part is made of inelastic material. The lid 9A shown in FIG. 5 is constituted of a part 90a formed with the slit 91, and the other part 90b. The part 90a is made of elastic material so that the slit 91 opens when applied with external force. The part 90b is made of inelastic material (resin material, for example).

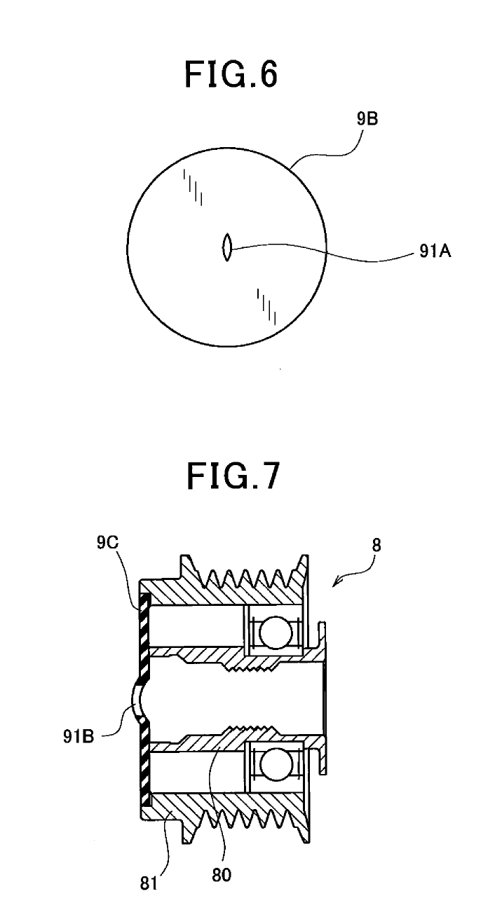

FIG. 6 is a diagram showing another modification of the lid 9. In the examples shown in FIG. 3 and FIG. 5, the lid 9 or 9A is closed when not applied with external force, and opens when applied with external force. However, they may be configured such that they are closed before the lid 9 or 9A is attached to the pulley unit 8, and opens when the lid 9 or 9A is attached to the pulley unit 8. The lid 9B shown in FIG. 6 is formed with a slit 91A at its center. The slit 91A is configured such that it is open before the lid 9B is attached to the pulley unit 8, and is closed when the lid 9B is attached to the pulley unit 8. The lids 9 and 9A shown in FIGS. 3 and 5 have a shape of perfect circle. On the other hand, the lid 9B has a shape of an ellipse whose major axis is along the longitudinal direction of the slit 91A, and whose minor axis is along the direction perpendicular to the longitudinal direction of the slit 91A. When the lid 9B is attached to the pulley unit 8, it is applied with a force acting to close the slit 91A along the major axis.

According to the lid 9B, it is possible to provide an air passage by the slit 91A which is open at the time of attaching the lid 9B to the pulley unit 8, and to close the slit 91A after the lid 9B is attached to the pulley unit 8 to prevent entry of foreign matter to the inside of the pulley unit 8.

FIG. 7 is a diagram showing another modification of the lid 9. The lid 9C shown in FIG. 7 is made of elastic material, and has a convex portion at its center which projects in the direction opposite to the internal space when it is attached to the pulley unit 8. A slit 91B is formed in this convex portion. The slit 91B is closed when no external force is applied.

According to the lid 9C, it is possible to easily provide an air passage by pressing the convex portion of the lid 9C to cause the slit 91B to open at the time of attaching the lid 9C to the pulley unit 8. To attach the lid 9C to the pulley unit 8, the lid attaching jig 100 can be used if it is modified to make the pressing surface 100A flat by eliminating the convex portion 100B.

According to the lid 9C, it is possible for the air in the internal space of the pulley unit 8 to escape by pressing the convex portion to cause the slit 91B to open at the time of attaching the lid 9C to the pulley unit 8. After completion of the attaching work of the lid 9C, the slit 91B can be closed only by removing the pressing force to the convex portion.

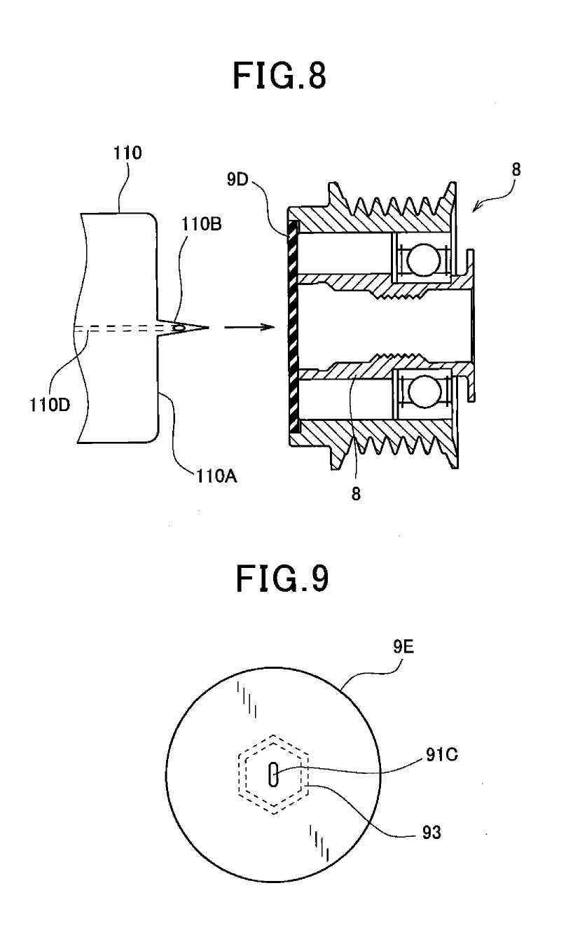

FIG. 8 is a diagram showing another modification of the lid 9. The lid 9D shown in FIG. 8 is made of elastic material like the lid 9 shown in FIG. 3. However, the lid 9D is different from the lid 9 in that no slit is formed before it is attached to the pulley unit 8. Attaching of the lid 9D to the pulley unit is performed using a lid attaching jig 110 shown in FIG. 8. The lid attaching jig 110 includes a pressing surface 110A having the same diameter as the lid 9D, and formed with a conical concave portion 110B at its center. The lid attaching jig 110 is formed with an air passage 1100 thereinside. The air passage 110D connects to an opening formed in the lateral side of the convex portion 110B.

At the time of attaching the lid 9D to the pulley unit 8 by performing step B, the whole of the surface of the lid 9D is pressed by the lid attaching jig 110 with the convex portion 110B of the lid attaching jig 110 being stabbed into the center portion of the lid 9D. By forcing the convex portion 110B into the lid 9D, a slit is formed in the center portion of the lid 9D as an air passage. Since the convex portion 110B is formed with the opening connecting to the air passage 110D, the air in the internal space of the pulley unit 8 can escape through this opening. Further, since the lid 9D is made of elastic material, when the lid attaching jig 110 is removed after the lid 9D is attached to the pulley unit 8, the slit (air passage) formed by the convex portion 110B is closed.

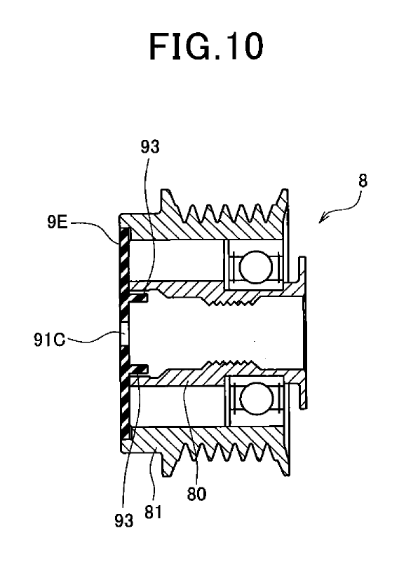

FIGS. 9 and 10 are diagrams showing another modification of the lid 9. The lid 9E shown in FIG. 9 includes a hole 91C formed in its center portion. Unlike the slit 91 of the lid 9, the hole 91C of the lid 9E is always open to serve as an air passage. The lid 9E includes a wall portion 93 surrounding the hole 91C, a height direction of which is along the front end portion of the pulley shaft 80 and the rotation shaft 33. When the inner periphery of the front end portion of the pulley shaft 80 has a hexagonal cross-sectional shape, for example, the wall portion 93 has a hexagonal cross-sectional shape which is similar to and slightly smaller than that of the inner periphery of the front end portion of the pulley shaft 80 as shown in FIG. 9. This makes it possible to form a labyrinth structure between the wall portion 93 and the front end portion of the pulley shaft 80, as a result of which foreign matter having entered the internal space of the pulley unit 8 through the hole 91C is prevented from spreading all over the internal space.

Incidentally, the wall portion 93 does not necessary have to have an analogous cross-sectional shape as the front end portion of the pulley shaft 80, as long as a labyrinth structure is formed between the wall portion 93 and the front end portion of the pulley shaft 80. Although the example shown in FIGS. 9 and 10 is a combination of the hole 91C which is always open and the wall portion 93, a combination of the slit 91 shown in FIG. 3 and the wall portion 93 may be employed. In this case, even if the lid 9 is applied with external force by some reason to cause the slit 91 to open, and foreign matter enters the internal space of the pulley unit 8, it is possible to prevent the foreign matter from spreading all over the internal space.

It is a matter of course that various modifications can be made to the above described embodiment. For example, although the above embodiment is directed to a vehicle AC generator, the present invention can be also applied to a vehicle rotating machine which operates as both a motor and a generator, or as only a. motor.

The above described embodiment explains how the lid is attached to the front end opening of the pulley unit 8 having the clutch function. However, the present invention is applicable also to a case where a lid is attached to an opening of a pulley unit including a coil-like spring in its internal space as described in the foregoing Patent Document 3, and a case where a lid is attached to an opening of a pulley having a simple structure having no clutch function, and only having grooves formed on the outer periphery of a cylindrical section thereof.

The above explained preferred embodiments are exemplary of the invention of the present application which is described solely by the claims appended below. It should be understood that modifications of the preferred embodiments may be made as would occur to one of skill in the art.

What is claimed is:

1. A vehicle electric rotating machine: comprising:
a rotor including a rotation shaft rotatably supported by a first bearing;
a pulley unit having an opening portion formed in an axial front end thereof, and configured to perform at least one of transmission and reception of a rotation drive force to and from the rotation shaft; and
a lid attached to the opening portion to close an internal space of the pulley unit;
the rotor including a rotor side receiving surface in contact with a first axial end surface of an inner ring of the first bearing,
the pulley unit including a pulley side receiving surface in contact with a second axial end surface of the inner ring of the first bearing,
wherein an air passage enabling air communication between the internal space of the pulley unit closed by the lid and ambient space of the pulley unit is formed in at least one of the rotor side receiving surface, the pulley side receiving surface, and the lid.

2. The vehicle electric rotating machine according to claim 1, wherein the pulley unit includes a pulley shaft fixedly mounted on the rotation shaft, and a pulley formed with pulley grooves at an outer periphery thereof and disposed concentrically outwardly of the pulley shaft through a second bearing, the pulley unit being provided with a one-way clutch mechanism configured to transmit the rotation drive force in a predetermined direction transmitted from a vehicle engine to the pulley shaft.

3. The vehicle electric rotating machine according to claim 1, wherein clearance exists between the inner ring and the rotation shaft passing through the inner ring, and the air passage is a groove formed on at least one of an intimate contact surface between the first axial end surface of the inner ring and the rotor side receiving surface, and an intimate contact surface between the second axial end surface of the inner ring and the pulley side receiving surface.

4. The vehicle electric rotating machine according to claim 1, wherein the lid is made of elastic material, and the air passage is a slit formed in the lid, the lid being configured such that the slit is closed when no external force is applied thereto.

5. The vehicle electric rotating machine according to claim 1, wherein the lid is made of elastic material, and the air passage is a slit formed in the lid, the lid being configured such that the slit is open when the lid is not attached to the opening portion of the pulley unit and is closed when the lid is attached to the opening portion of the pulley unit.

6. The vehicle electric rotating machine according to claim 1, wherein the air passage is a slit formed in the lid, a portion of the lid including the slit is made of elastic material, the lid being configured such the that the slit is closed when no external force is applied thereto.

7. The vehicle electric rotating machine according to claim 1, wherein the lid is made of elastic material, the air passage is a slit formed in the lid, a portion of the lid including the slit having a convex shape projecting in a direction opposite to the internal space of the pulley unit, the lid being configured such that the slit is closed when no external force is applied thereto.

8. The vehicle electric rotating machine according to claim 1, wherein the air passage is a hole formed in the lid, the lid including a wall portion located inside the internal space to as to surround the hole, a height direction of the wall portion being along a portion of the pulley shaft located at a front end side of the pulley unit, and the rotation shaft.

9. The vehicle electric rotating machine according to claim 1, wherein the air passage is a slit formed in the lid, and the lid includes a wall portion located inside the internal space of the pulley unit so as to surround the slit, a height direction of the wall portion being along a portion of the pulley shaft located at a front end side of the pulley unit, and the rotation shaft.

10. A method of manufacturing a vehicle electric rotating machine including a rotor having a rotation shaft rotatably supported by a first bearing, a pulley unit having an opening portion formed in an axial front end thereof, and configured to perform at least one of transmission and reception of a rotation drive force to and from the rotation shaft, and a lid attached to the opening portion to close an internal space of the pulley unit,
the method comprising the steps of:
assembling the pulley unit to an axial front end of the rotation shaft; and
attaching the lid to the opening portion of the pulley unit while forming an air passage in the lid to enable air communication between the internal space of the pulley unit closed by the lid and ambient space of the pulley unit.

11. The method of manufacturing a vehicle electric rotating machine according to claim 10, wherein the lid is configured such that the air passage is open when the lid is not attached to the opening portion of the pulley unit, and closed after the lid is attached to the opening portion of the pulley unit.

12. The method of manufacturing a vehicle electric rotating machine according to claim 11, wherein the lid is made of elastic material, and the air passage is a slit formed in the lid, the slit being in a closed state when no external force is applied thereto, and being brought to an open state by being applied with external force at the time of attaching the lid to the opening portion of the pulley unit, and being brought to the closed state by removing the external force after the lid is attached to the opening portion of the pulley unit.
